(19) United States
(12) Patent Application Publication
(10) Pub. No.: US 2012/0125868 A1
(43) Pub. Date: May 24, 2012

(54) METHOD OF SEPARATING TWO DISPERSED-PHASE IMMISCIBLE LIQUIDS

(76) Inventors: Stefano Falappi, Gouvieux (FR); Thierry Palermo, Asson (FR); Christine Noik, Le Pecq (FR); Benjamin Brocart, Billere (FR); Alain Ricordeau, Pau (FR)

(21) Appl. No.: 13/265,580

(22) PCT Filed: Apr. 21, 2010
(86) PCT No.: PCT/FR2010/000320

§ 371 Date: Feb. 14, 2012

(30) Foreign Application Priority Data
Apr. 23, 2009 (FR) 09/01985

(51) Int. Cl. B01D 17/025

(52) U.S. Cl. 210/800

(57) ABSTRACT

Method of separating two dispersed-phase immiscible liquids. The two liquids are fed into a gravity separator where both liquids are separated by decantation. A first phase consisting of a first liquid is obtained at the bottom of the separator, a second phase consisting of the second liquid is obtained at the tap of the separator, a third phase containing the two dispersed-phase immiscible liquids and a fourth phase containing the two immiscible liquids in a dense bed are obtained. Physico-chemical properties of the liquids and of the dispersed phase are measured, and a physical separation model is defined. This model is defined considering that the separator works under stationary conditions, using a matter conservation balance for the first fluid within the dense bed, while taking account of a first phenomenon of coalescence between water drops within the third phase, and of a second phenomenon of coalescence between water drops of the fourth phase and the first phase. This model is then used to optimize implementation of the separation. Application to the separation of petroleum effluents for example.

### FIELD OF THE INVENTION

The present invention relates to the sphere of treatment of effluents comprising two dispersed-phase immiscible liquids, such as petroleum effluents from production wells.

In particular, the invention relates to a method of separating two immiscible liquids in emulsion, notably water and liquid hydrocarbons.

It is important to separate the water from the liquid hydrocarbons produced so as to increase the quality thereof and to facilitate treatment and transport thereof. Now, after passage of the emulsified effluent through conventional water/hydrocarbon separators, the latter still contains 1 to 5% residual emulsified water in the liquid hydrocarbons.

It is important to decrease the amount of residual water in order to meet the technical specifications of downstream processes.

### BACKGROUND OF THE INVENTION

There are known techniques allowing to define the dimensions of gravity separators in order to improve separation. In most cases, a mean size is assumed for the water droplets at the separator inlet, around 100 microns, and the size of the separator is dimensioned by calculating a water drop fall time using sedimentation laws for a dispersion of spherical particles in a Newtonian fluid with small particle Reynolds numbers.

Under dilute flow conditions, the rate of sedimentation of a drop, which is likened to a sphere, is given by the Stokes velocity Vₛₜ:

$${V}_{st} = \frac{Δ ρ \cdot g \cdot {D}^{2}}{18 μ}$$

with:

D: mean diameter of the drops

g: acceleration of gravity

V_{St}: Stokes velocity (velocity for an isolated drop)

Δρ: density difference between water and oil phase

μ: continuous phase viscosity (oil).

Three laws of sedimentation under concentrated flow conditions (hindered settling) are conventionally used. These laws take account of the influence of the concentration in the dispersed phase on the sedimentation rate:
Richardson-Zaki's empirical law:

V=Vₛₜ·(1−φ)ⁿ

with:

V: sedimentation rate

φ: drop volume fraction

n: an exponent generally selected around 5.
Snabre-Mills' law for particle Reynolds numbers Rep <<1 based on more rigorous physical foundations:

$$V = {V}_{st} \cdot \frac{1 - φ}{1 + \frac{4.6 φ}{{( 1 - φ )}^{3}}}$$

with:

V: sedimentation rate
V=0 for

$$φ \geq {φ}_{m} = \frac{4}{7}$$

φₘ: maximum volume fraction of water.
Kozeny-Carman's law applicable to flows in porous media:

$$V = {V}_{st} \cdot \frac{{( 1 - φ )}^{3}}{10 \cdot φ}$$

with;

V: sedimentation rate,

These laws are conventionally used for sizing separators. However, using these laws does not allow to take account of coalescence phenomena between water drops and of the presence of a dense emulsion phase at the free water/emulsion interface. Thus, the separators are either oversized, which results in excessive cost and size, or undersized, which results in limited efficiency.

The object of the invention is an alternative method of separating two dispersed-phase immiscible liquids by means of a gravity separator. The method allows to optimize sizing of the separator and/or the separator operating conditions with respect to a constraint (cost, sizing, separation efficiency). The method is based on the modelling of the separation within a gravity separator by means of a physical model.

### SUMMARY OF THE INVENTION

The invention relates to a method of separating two dispersed-phase immiscible liquids, wherein the dispersed phase is fed into a gravity separator. Within this separator, the two liquids are separated by decantation during a sedimentation time T_{SED} during which a first phase consisting of a first liquid is obtained at the bottom of the separator, a second phase consisting of the second liquid is obtained at the top of the separator, a third phase containing the two dispersed-phase immiscible liquids and a fourth phase containing the two immiscible liquids in a dense bed are obtained. The method comprises the following stages:

a—measuring physico-chemical parameters of said liquids and of the dispersed phase,

b—defining a physical separation model as a function of said physico-chemical parameters and of parameters relative to the operation and the sizing of said separator, by considering that said separator works under stationary conditions, using a matter conservation balance for the first fluid within the dense bed to take account of a first coalescence between the first phase and first liquid drops present in the fourth phase, and using an evolution law of size D of the first liquid drops during separation so as to take account of a second coalescence between first liquid drops within the third phase,

c—using said model to determine at least one of said parameters, and

d—carrying out separation according to the values of said parameters.

According to an embodiment, the matter conservation balance for the first fluid within the dense bed leads to the equality of a volume of the first fluid (v_{W}) that has left the dense bed and a volume of the first fluid (v_{S}) that has entered the dense bed, and the volume of the first fluid (v_{W}) that has left the dense bed is defined as a function of a velocity N of passage of the first liquid contained in the fourth phase into the second phase. The volume of the first fluid (v_{S}) that has entered the dense bed can then be defined as a function of a surface area occupied by the third phase in a last section of the separator S_{EMUL}. Parameters S_{EMUL} and N can be determined as a function of the evolution law of size D of the first liquid drops during separation. According to this embodiment, this evolution law of size D of the first liquid drops during separation can be estimated by expressing a variation over time of a mean volume of the drops as a function of a coalescence efficiency and of a characteristic coalescence time during sedimentation, and the characteristic time can be expressed by taking account of the impacts between drops during sedimentation and interactions due to a flow in the horizontal direction of the liquids.

According to the invention, the dispersed phase can be an emulsion of water and oil, and the parameters determined in stage c can be selected from among the following parameters: sedimentation time T_{SED}, parameters relative to the separator sizing, parameters relative to the separator operation, physico-chemical properties of the liquids and of the dispersed phase. The parameters relative to the separator sizing can be selected from among the following parameters: length and radius of the separator, height of a downcomer of the separator. The parameters relative to the separator operation can be selected from among the following parameters:

parameters relative to the separator inlet conditions, such as: inlet flow rate (Q_{E}), fraction of the first liquid (φ_{O}) within the dispersed phase, height (h_{W}) of the first phase in the separator,

parameters relative to the decantation within the separator, such as: heights of the third (h_{S}) and fourth (h_{D}) phases in the separator, and residence time (T_{SED}) in the separator.

According to an embodiment, the parameter determined in stage c can be a coefficient of interfacial tension (σ) between the two liquids so as to have a fixed separation efficiency η, and an additive selected in such a way that the liquids in the dispersed phase respect the value of the determined interfacial tension coefficient (σ) is added to the dispersed phase.

According to another embodiment, the parameter determined in stage c can be length L of the separator so as to have a fixed separation efficiency η, and the separator is sized accordingly to carry out separation.

According to another embodiment, the parameter determined in stage c can be the inlet flow rate Q_{E} of the liquids so as to have a fixed separation efficiency η, and the two liquids are injected at this flow rate Q_{E} to carry out separation.

According to another embodiment, the parameter determined in stage c can be the efficiency η of the separator.

Finally, according to the invention, it is also possible to determine at least one of the following parameters relative to the liquid outflow from the separator: flow rates at the downcomer outlets (Q_{S/W}, Q_{S/H}), water fraction at the downcomer outlet (φ_{S}), separator efficiency (η), height of the sedimentation front (h_{S}), height of the interface between the third and fourth phases (h_{D}), water flow rate at a water outlet of the separator (Q_{W}), and surface area occupied by the third phase in a last section of the separator (S_{EMUL}).

### BRIEF DESCRIPTION OF THE FIGURES

Other features and advantages of the method according to the invention will be clear from reading the description hereafter of embodiments given by way of non-limitative examples, with reference to the accompanying figures wherein;

FIG. 1 shows a flow chart of the method according to the invention,

FIG. 2 diagrammatically shows the division into three zones of a horizontal gravity separator,

FIGS. 3A, 3B and 3C diagrammatically show the stable stratified flow under steady state conditions leading to the distinction of four phases in the separator,

FIG. 4 shows the curve of the water volume (v_{S}) that reaches the dense bed through sedimentation and the curve of the water volume (v_{W}) that leaves the dense bed through coalescence with the free water phase, as a function of the various height values of the emulsion/dense emulsion interface (h_{D}),

FIG. 5 illustrates the notion of last section of the separator, the surface area occupied (S_{EMUL}) by the emulsion in this last section, and the surface available (S_{DISP}) for passage of the emulsion and of the oil already separated in the separator.

### DETAILED DESCRIPTION

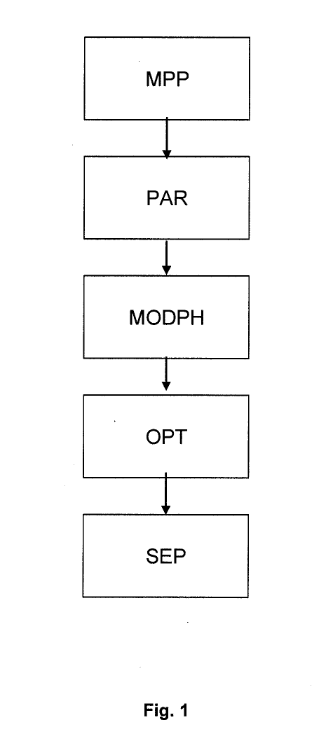

FIG. 1 shows a flow chart of the alternative method of separating two dispersed-phase immiscible liquids according to the invention.

The method essentially comprises the following stages:

1—Measurement of physico-chemical properties relative to the liquids and to the dispersed phase (MPP)

2—Selection of predetermined parameters linked with the operation and the sizing of the separator (PAR)

3—Definition of a physical separation model according to the parameters (MODPH)

4—Using the model for determining all the non-fixed parameters and carrying out separation while respecting the values of the parameters (OPT, SEP).

The nomenclature used in the description is given in detail in Appendix 1.

According to a particular embodiment example, a horizontal gravity separator of cylindrical shape is used to separate an oil and water emulsion.

1—Measurement of Physico-Chemical Properties Relative to the Liquids and to the Dispersed Phase

The following physico-chemical properties of the water and of the oil are determined in the laboratory using techniques known per se:

ρ_{H}: oil density

ρ_{W}: water density

μ: oil viscosity

σ; coefficient of interfacial tension between the oil and the water.

Furthermore, a value is defined for the following properties specific to the emulsion:

Φₘ, maximum volume fraction of water, ranging between 0.65 and 07

φ_{D}, volume fraction of water in the dense bed, also ranging between 0.65 and 07.

2—Selection of Parameters Linked with the Operation and the Sizing of the Separator

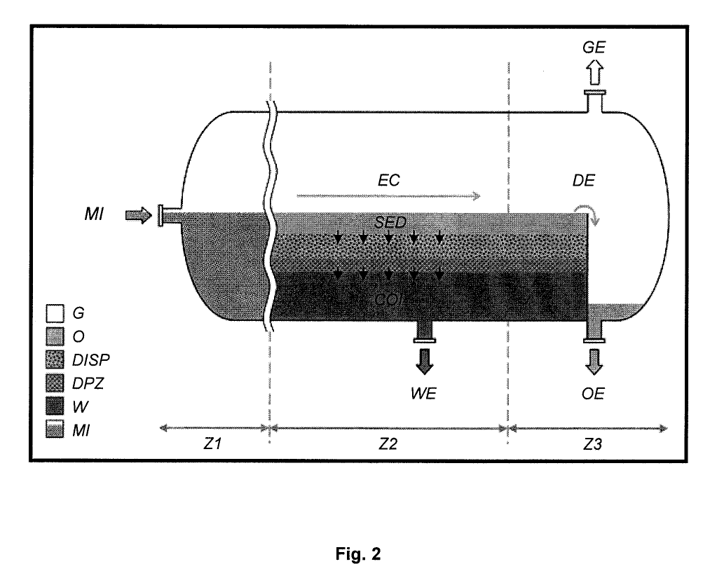

Horizontal gravity separators are large cylindrical tanks (FIG. 2) into which a mixture MI of oil and water (and possibly gas) is fed continuously in order to obtain two (or three) distinct and uniform phases at the outlet. The density difference of these phases allows separation thereof.

A separator has to be sized so as to allow sufficient time for the drops of the dispersed phase to reach the interface and coalesce (COL) therewith. Their diameter generally ranges between 3 and 5 m and their length between 15 and 30 m.

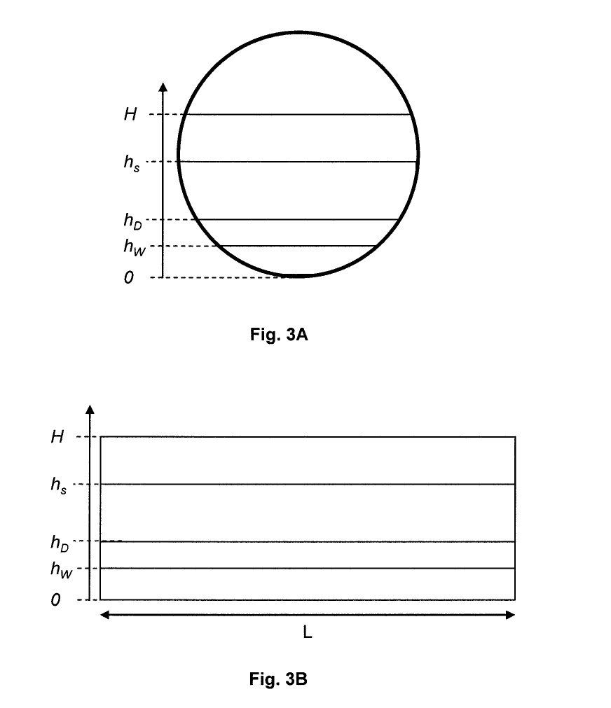

A horizontal gravity separator can be divided into three zones (FIG. 2). The separator inlet (zone 1—Z1) is provided with equipments such as perforated plates, baffles or gratings allowing to prevent formation of a jet at the inlet and reducing the velocity and the turbulence of the dispersion. Once through the supply zone, the dispersion flows along the decanter, as shown by arrow EC in FIG. 2, and reaches stabilized running conditions within a decantation zone (zone 2—Z2). Simultaneously, the drops of the dispersed phase settle (SED) vertically. When they reach the interface, the drops accumulate, thus forming a dense emulsion zone prior to coalescing with their homophase. The formation of this dense emulsion zone is due to the difference between the characteristic times of sedimentation and of coalescence: in most cases, the drops settle more rapidly than they coalesce with the interface. They therefore accumulate above this interface and form a dense-packed emulsion zone (DPZ) (dense bed). This zone thus consists of a stack of drops of different sizes, and it can be considered to be stationary in relation to the main flow in the separator. Under steady state conditions, it can be considered that, in zone 2, a stable stratified flow consisting of four phases (FIG. 3) is obtained, thus characterized from top to bottom:

a phase consisting practically only of oil above the separator, referred to as oil zone or dispersion. The interface between the oil phase and the gas above is positioned at height H equal to the height of the downcomer,

below, an intermediate water-in-oil emulsion phase with a volume fraction equal to the inlet volume fraction. The interface between the oil phase and the emulsion phase is at height h_{S},

below, a water-in-oil emulsion phase with a volume fraction close to the maximum volume fraction (dense bed). The interface between the emulsion phase and the dense bed is at height h_{D}. The thickness of the dense bed is typically constant (h_{D}-h_{W} is a constant),

below, a phase consisting of practically pure water, at the separator bottom, is referred to as the free water phase. Height h_{W} of the free water phase is maintained constant in the separator.

In the example of FIG. 2, the phases are denoted as follows: gas (G), oil (O), dispersion (DISP), dense bed (DPZ), water (W), initial mixture (MI).

The length of zone 2 is denoted by L. This length is defined as the “effective” length of the separator, considering that the phase separation phenomenon occurs only in this zone.

The hypothesis of free water phase thickness uniformity over the entire length of the decantation zone is acceptable because of the low viscosity of the water. On the other hand, the same hypothesis for the dense bed is not ensured. However, measurements have shown that the thickness variation of the dense bed is low. One therefore assumes a constant dense bed thickness, equal to the mean value of its thickness over the length of the decantation zone.

The water outlet (WE) is in zone 2: it allows to adjust the height of free water phase by acting upon a pump arranged downstream, on the water branch connection of the separator.

At the end of the decanter, the discharge zone (zone 3—Z3) allows the liquid hydrocarbons, commonly referred to as oil, to flow over a downcomer (DE) and to leave the separator (OE). Gas may optionally flow out through an outlet GE. If the residence time of the effluents in the separator is sufficient, the oil thus recovered is freed of the major part of the water.

The flow rate of the effluents entering the separator is denoted by Q_{E}. These effluents are characterized by a water volume fraction φ₀. The effluents leave the separator either through the downcomer with a flow rate Q_{S} consisting of an oil flow rate Q_{S/H} and of a water flow rate Q_{S/W}, or through the water branch connection with a flow rate Q_{W}.

Flow rate Q_{S} is characterized by a water volume fraction φ_{S} that can range between 0 in case of complete separation and φ₀ in the absence of separation. Flow rate Q_{S} con thus be divided into two parts: the flow rate of the residual water in the emulsion (Q_{S/W}=Q_{S}φ_{S}) and the flow rate of oil at the downcomer outlet (Q_{S/H}=Q_{S}(1−φ_{S})=Q_{E}(1−φ₀)).

The parameters linked with the operation and the sizing of the separator can be grouped into four sets:

a—parameters relative to the geometry of the separator (length L and radius R of the separator, height H of the downcomer),
b—parameters relative to the separator inlet conditions: inlet flow rate (Q_{E}) and water fraction (φ₀) within the dispersed phase,
c—parameters relative to the decantation phenomenon within the separator: height (h_{W}) of water in the separator, heights h_{S} and h_{D} respectively of the emulsion and of the dense bed in the separator, and residence time (T_{SED}) in the separator,
d—parameters relative to the liquid outflow from the separator: flow rates at the outlets, water fraction at the downcomer outlet and separator efficiency.

3—Definition of a Physical Separation Model as a Function of the Parameters

In order to model the separation phenomena in zone 2 (decantation zone of the separator), we consider that the separator works under stationary conditions (the method is applicable to a separator for which there is at least one stationary working point). In a separator under stationary flow conditions, we can consider that two main phenomena take place:

decantation, corresponding to the phenomenon of sedimentation of the water drops dispersed in the emulsion and reaching the dense bed. This phenomenon is characterized by a water flow rate;

coalescence of the water drops of the dense bed with the free water phase, denoted by COI in FIG. 2. This phenomenon is characterized by the water flow rate Q_{W} leaving the dense bed through interfacial coalescence with the free water phase.

Considering that the separator works under stationary conditions, a conservation balance of matter on the water in the dense bed can be established, this balance leading to the volume equality as follows:

v_{W}=v_{S}

Thus, the water volume v_{W} leaving the dense bed (through coalescence between the drops of the dense bed and the water) is equal to the water volume v_{S} that has entered the dense bed (sedimentation of the emulsion drops). In other words, the water that gets into the dense bed through decantation coalesces with the free water phase.

Considering that, under steady state conditions, the thickness of the dense bed is uniform in the separator (and therefore the horizontal velocity of the drops in the dense bed is zero), we can write;

v_{W}=B_{W}·L·N·T_{Sed}

with:

T_{SED}: sedimentation time in the separator

N: velocity of passage through interface h_{W} of the water present in the dense bed (this velocity can be seen as the velocity of the interface between the water and the dense bed, if the water was not emptied out)

L: length of the separator

B_{W}: width of the interface between the free water phase and the dense bed at height h_{W} (FIG. 3C).

Velocity N depends on the physico-chemical properties relative to the liquids, to the dispersed phase, to the parameters linked with the sizing of the separator and to the parameters linked with the operation of the separator.

Considering also that the volume of liquid flowing from the downcomer corresponds to the volume of liquid above the dense bed that is found in the last section of the separator, we can write:

v_{S}=φ₀Q_{R}T_{Sed}−φ₀S_{Emul}L

with:

S_{Emul}: surface area occupied by the emulsion in the last section of zone 3 of the separator, i.e. the section in connection with the downcomer.

Surface area S_{EMUL} depends on the physico-chemical properties relative to the liquids, to the dispersed phase, to the parameters linked with the sizing of the separator and to the parameters linked with the operation of the separator.

According to the invention, volumes v_{S} and v_{W} are determined by taking into account the coalescence phenomena within the separator, in particular the fact that there are two types of coalescence:

coalescence of the water drops in the emulsion, which corresponds to the impacts between drops upon decantation,

coalescence between water drops and the free water phase at the level of the dense bed/water interface.

S_{EMUL} and N can therefore be determined by considering an evolution in the size of the water drops during sedimentation. The mean diameter of the drops is denoted by D. We consider that, in the separator, at a certain time, all the drops have the same size, D directly depends on the sedimentation time T_{SED} in the separator. D takes account of the collisions due to the flow in the separator: the impacts between the drops during sedimentation and the interactions due to the flow in the horizontal direction,

1) The variation over time of the mean volume of the drops v(v=(π/6)D³), in relation to the initial volume v₀, is expressed as follows:

$$\frac{d v / {v}_{0}}{d t} = α \frac{1}{{τ}_{o}} \qquad Eq . 8$$

with:

α: coalescence efficiency during sedimentation

τ_{c}: characteristic coalescence time during sedimentation.

2) We want the frequency of collision between the drops to also take into account the collisions due to the flow in the separator:

$$\frac{1}{{τ}_{c}} = \frac{{V}_{St 0} {f}_{0}}{D [ {( \frac{{φ}_{m}}{{φ}_{0}} )}^{1 / 3} - 1 ]} - \frac{D}{{D}_{o}^{2}} + \overline{K} \qquad Eq . 9$$

with:
Suffix 0 indicates a value at the time t=0.
f(φ): term of dependence at in the expression of the sedimentation rate V=Vst·f(φ). Here: f(φ₀)=(1−φ₀)⁵³.
f₀: f₀=f(φ₀)=1−φ₀)^{5.3}
Φₘ: maximum volume fraction of water
φ₀: water fraction at the time t=0
D: mean diameter of the drops
D₀: mean diameter of the drops at the time t=0
Vst₀: Stokes velocity at the time t=0:

$${Vst}_{0} = \frac{Δρ {gD}_{0}^{2}}{18 μ}$$

K̅: mean gradient of the horizontal velocity in the available section

$$\overline{K} = \frac{6}{π} {φ}_{0} \frac{{Q}_{E}}{{S}_{Disp} ( H - {h}_{D} )}$$

S_{Disp}: available surface area for passage of the emulsion.

The first right-hand side term of Equation 9 takes account of the impacts between the drops during sedimentation. The frequency of these impacts is expressed as the ratio of the mean distance between drops at a characteristic velocity selected proportional to the rate of sedimentation.

The second right-hand side term of Equation 9, K̅, considers the interactions due to the flow in the horizontal direction. Term K̅ is proportional to the mean gradient of the velocity in the available section, evaluated by assuming a laminar flow.

According to an embodiment, the following models, whose foundation is described in Appendix 2, are used;

$$\begin{matrix} {S}_{𝕀 MUL} = {f}_{1} ( {h}_{s} , R , L , H ) and \\ {h}_{s} = H - \frac{1}{3} α [ \frac{{Vst}_{0}^{2}}{{D}_{0}} - \frac{{f ( {φ}_{0} )}^{2}}{{( \frac{{φ}_{m}}{{φ}_{0}} )}^{1 / 3} - 1} + {Vst}_{0} f ( {φ}_{0} ) \frac{{D}_{0}}{D} \overline{K} ] {T}_{Sed}^{2} - {Vst}_{0} f ( {φ}_{0} ) {T}_{Sed} & a ) \\ N = \frac{β \frac{Δρ g {φ}_{D}}{μ} ( {h}_{D} - {h}_{W} )}{1 + β \frac{180}{{D}^{2}} \frac{{φ}_{D}^{2}}{{( 1 - {φ}_{D} )}^{3}} ( {h}_{D} - {h}_{W} )} & b ) \\ D = \sqrt{\frac{2}{3} α [ \frac{{Vst}_{0} f ( {φ}_{0} ) {D}_{0}}{{( \frac{{φ}_{m}}{{φ}_{0}} )}^{1 / 3} - 1} + {D}_{0}^{2} \overline{K} ] {T}_{SED} + {D}_{0}^{2}} & c ) \\ {T}_{Sed} = \frac{{S}_{Disp} L}{{Q}_{E}} , & d )\end{matrix}$$

where T_{Sed} is the residence time of the emulsion in the separator.

According to an embodiment, parameters D₀ and α are determined by means of a calibration performed through bottle test. This technique is well known to specialists and it is described for example in:
1, Lissant, K. J., “Demulsification-Industrial Application”, Surfactant Science Series, Vol. 13, Marcel Dekker, New York (1983).
2. Kokal, S., “Crude oil emulsions: a state of the art review”, In Proceedings SPE ATCE, San Antonio, Tx, 29/09-2/10 2002, SPE paper no 77497.

4—Using the Model for Determining all the Non-Fixed Parameters and Carrying Out Separation while Respecting the Values of the Parameters

The unknown of the model is the position h_{D} of the interface between the dense bed and the emulsion. In this model, several quantities depend on h_{D} and there is no analytical solution for this equation, i.e. it is not possible to extract from this model an equation of the form as follows: h_{D}=j(p₁, p₂, . . . ), where j is a function and p₁, p₂, . . . are parameters independent of h_{D}. We then say that h_{D} cannot be explicitated from the model. The equation is referred to as “implicit”.

According to an embodiment of the invention, the procedure is as follows:

The position of interface h_{D} is considered to be the independent variable. It can vary between height h_{W} of the free water phase and height H of the downcomer. This variation interval (H−h_{W}) is discretized into n segments. A value of h_{D} referred to as h_{D}* is selected for each segment. This value allows to calculate an available section, therefore a residence time T*_{Sed}, a surface area occupied by the emulsion in the last section and a velocity value N*.

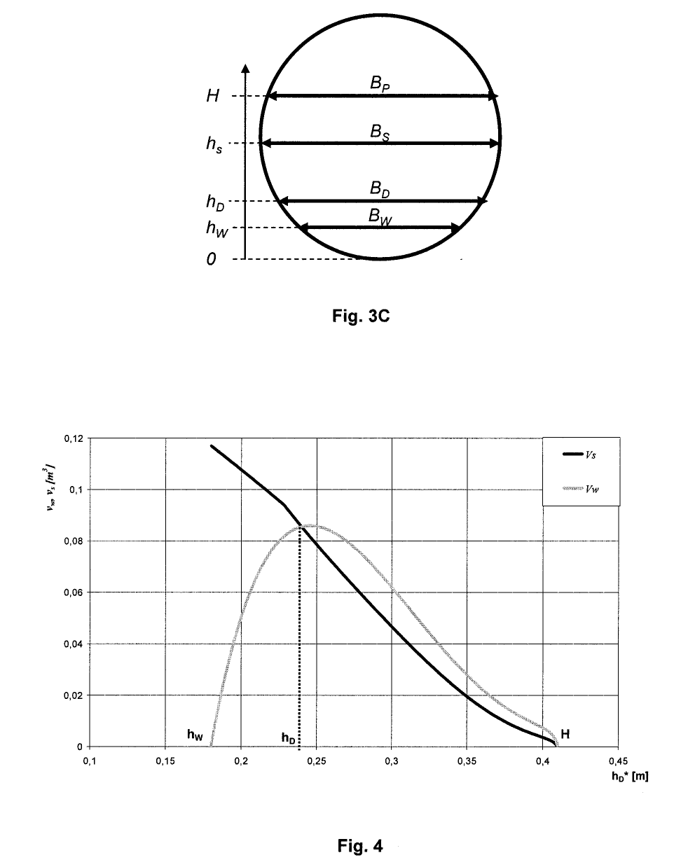

For each segment (each value of h_{D}*), we calculate the values of v_{S} and v_{W}, and we plot curves of the two volumes as a function of h_{D}*, by interpolation. FIG. 4 shows curves v_{S} and v_{W} as a function of the value of h_{D}*. We can then determine the point of intersection of the curves, which corresponds to the equality of the volumes. The abscissa of this point gives the value of h_{D} sought, which allows to directly calculate T_{SED}.

The water fraction at the outlet can also be evaluated with the following equation;

$${φ}_{S} = {φ}_{0} \frac{{Q}_{S / W}}{{Q}_{S}}$$

A separation efficiency of the separator can then be defined:

$$η = 1 - \frac{{φ}_{S}}{{φ}_{0}}$$

The model thus allows to determine sedimentation time T_{SED} and, at the same time: h_{S}, S_{EMUL}, h_{D}, Q_{W}, Q_{S/W}, Q_{S/H}, φ_{S}.

Furthermore, by fixing all the parameters of the model but one, it is possible to determine the optimum value of the non-fixed parameter. Thus, using this model allows for example to:

determine the separator geometry necessary to obtain a fixed separation efficiency and knowing the parameters relative to the operation of the separator and the physico-chemical properties of the liquids and of the emulsion;

determine the inlet flow rate (Q_{E}) or the water fraction (φ₀) within the dispersed phase or the water height (h_{W}) in the separator, necessary to obtain a fixed separation efficiency, knowing the parameters relative to the operation of the separator, the parameters relative to the sizing of the separator and the physico-chemical properties of the liquids and of the emulsion;

determine the flow rates at the outlets or the water fraction at the outlet of the downcomer or the separator efficiency, knowing the parameters relative to the operation of the separator, the parameters relative to the sizing of the separator and the physico-chemical properties of the liquids and of the emulsion;

determine the additives for improving separation, knowing the parameters relative to the operation of the separator, the parameters relative to the sizing of the separator and the physico-chemical properties of the liquids and of the emulsion.

An example of application of each one of these uses is described hereafter.

i. Determining Length L of the Separator to have a Separation Efficiency n

Known data
Geometry

| | |
|---|---|
| R = 0.35 m | H = 0.4 m |

Physico-chemical properties of the fluids

| | | |
|---|---|---|
| ρ_{H} = 810 kg/m³ | ρ_{W} = 1000 kg/m³ | μ = 0.004 Pa s |
| σ = 0.003 N/m | Φₘ = Φ_{D} = 0.65 | |

Operating conditions

| | | |
|---|---|---|
| Q_{E} = 10 m³/h | Φ₀ = 0.3 | h_{W} = 0.18 m (B_{W} = 0.6118 m) |

Emulsion properties at the inlet

| | |
|---|---|
| D₀ = 100 μm | α = 0.8 |

Fixed efficiency

η = 0.95

Results

| | | |
|---|---|---|
| L = 2.83 m | T_{Sed} = 91.87 s | h_{D} = 0.28 m |

Other results

| | | |
|---|---|---|
| h_{S} = 0.287 m | Sₑₘᵤₗ = 0.005 m² | |
| Q_{W} = 2.9 m³/h | Q_{S/W} = 0.10 m³/h | Q_{S/H} = 7 m³/h |
| Φ_{S} = 0.014. | | |

ii. Determining Inlet Flow Rate Q_{E} in Order to have a Separation Efficiency n

Known data
Geometry

| | | |
|---|---|---|
| L = 2.5 m | R = 0.35 m | H = 0.4 m |

Physico-chemical properties of the fluids

| | | |
|---|---|---|
| ρ_{H} = 810 kg/m³ | ρ_{W} = 1000 kg/m³ | μ = 0.004 Pa s |
| σ = 0.003 N/m | Φₘ = Φ_{D} = 0.65 | |

Operating conditions

| | |
|---|---|
| Φ₀ = 0.3 | h_{W} = 0.18 m (B_{W} = 0.6118 m) |

Emulsion properties at the inlet

| | |
|---|---|
| D₀ = 100 μm | α = 0.8 |

Fixed efficiency

η = 0.95

Results

| | | |
|---|---|---|
| Q_{E} = 8.8 m³/h | T_{Sed} = 92 s | h_{D} = 0.28 m |

Other results

| | | |
|---|---|---|
| h_{S} = 0.287 m | Sₑₘᵤₗ = 0.005 m² | |
| Q_{W} = 2.55 m³/h | Q_{S/W} = 0.08 m³/h | Q_{S/H} = 6.24 m³/h |
| Φ_{S} = 0.014. | | |

iii. Determining Efficiency n of the Separator

Known data
Geometry

| | | |
|---|---|---|
| L = 2.5 m | R = 0.35 m | H = 0.4 m |

Physico-chemical properties of the fluids

| | | |
|---|---|---|
| ρ_{H} = 810 kg/m³ | ρ_{W} = 1000 kg/m³ | μ = 0.004 Pa s |
| σ = 0.003 N/m | Φₘ = Φ_{D} = 0.65 | |

Operating conditions

| | | |
|---|---|---|
| Q_{E} = 10 m³/h | Φ₀ = 0.3 | h_{W} = 0.18 m (B_{W} = 0.6118 m) |

Emulsion properties at the inlet

| | |
|---|---|
| D₀ = 100 μm | α = 0.8 |

Results

| | | |
|---|---|---|
| η = 0.76 | T_{Sed} = 78.26 s | h_{D} = 0.285 m |

Other results

| | | |
|---|---|---|
| h_{S} = 0.32 m | Sₑₘᵤₗ = 0.024 m² | |
| Q_{W} = 2.45 m³/h | Q_{S/W} = 0.55 m³/h | Q_{S/H} = 7 m³/h |
| Φ_{S} = 0.07. | | |

iv. Determining the Value of Interracial Tension Coefficient σ (Function of the Additives) in Order to have a Separation Efficiency n

Known data
Geometry

| | | |
|---|---|---|
| L = 2.5 m | R = 0.35 m | H = 0.4 m |

Physico-chemical properties of the fluids

| | | |
|---|---|---|
| ρ_{H} = 810 kg/m³ | ρ_{W} = 1000 kg/m³ | μ = 0.004 Pa s |
| Φₘ = Φ_{D} = 0.65 | | |

Operating conditions

| | | |
|---|---|---|
| Q_{E} = 10 m³/h | Φ₀ = 0.3 | h_{W} = 0.18 m (B_{W} = 0.6118 m) |

Emulsion properties at the inlet

| | |
|---|---|
| D₀ = 100 μm | α = 0.8 |

Fixed efficiency

η = 0.95

Results

| | | |
|---|---|---|
| σ = 0.0008 N/m | T_{Sed} = 105.9 s | h_{D} = 0.239 m |

Other results

| | | |
|---|---|---|
| h_{S} = 0.249 m | Sₑₘᵤₗ = 0.006 m² | |
| Q_{W} = 2.9 m³/h | Q_{S/W} = 0.1 m³/h | Q_{S/H} = 7 m³/h |
| Φ_{S} = 0.014. | | |

Separation is then carried out by means of the separator while respecting the fixed sizing and operating parameters or those determined by means of the physical separation model.

According to example iv, an additive selected in such a way that the interfacial tension coefficient σ in the emulsion has the determined value is added to the emulsion.

According to example iii, efficiency η of the separator is determined. This allows to determine whether it is necessary to optimize the separation parameters.

By means of the model, we also determine: h_{S}, S_{Emul}, h_{D}, Q_{W}, Q_{S/W}, Q_{S/H}, φ_{S}.

### APPENDIX 1

### Nomenclature

Suffix₀: value at the time t=0

D: mean diameter of the drops

f(Φ): term of dependence at φ in the expression of the sedimentation rate

V=V_{St}f(φ): for example for Richardson-Zaki: f(φ)=(1−φ)ⁿ

g: acceleration of gravity

h: space variable (height)

H: initial height of the emulsion in the static case/height of the downcomer in the dynamic case

h_{D}: height of the emulsion/dense emulsion interface

h_{W}: height of the water/dense emulsion interface

h_{S}: height of the sedimentation front

V: sedimentation rate

V_{St}: Stokes velocity (velocity for an isolated drop)

α: coalescence efficiency during sedimentation

β: parameter characteristic of the interfacial film at the water/dense emulsion interface

Δρ: density difference between the water and oil phase

φ, φₘ, φ₀: water volume fraction, maximum water volume fraction, water volume fraction at t=0

φ_{D}: water volume fraction in the dense bed

v: mean volume of the drops

μ: continuous phase viscosity (oil)

π: pressure exerted by the dense emulsion column on the water/dense emulsion interface

τ_{c}: characteristic coalescence time during sedimentation

Q_{E}: emulsion flow rate at separator inlet

Q_{S}: flow rate at downcomer outlet

Q_{S/H}: oil flow rate at downcomer outlet

Q_{S/W: water flow rate at downcomer outlet}

Q_{W}: water flow rate at water outlet

S_{Disp}: available surface for emulsion passage

V_{moy}: mean horizontal velocity of the flow in the separator

T_{Sed}: residence time

v_{S}: water volume that reaches the dense bed through sedimentation

v_{W}: water volume leaving the dense bed through coalescence with the free water phase

K̅: mean gradient of the horizontal velocity in the available section

φ_{S}: water volume fraction at downcomer outlet

η: separation efficiency.

### APPENDIX 2

### Determination of Volumes v_{W} and v_{S}

We consider that, under steady state conditions, the thickness of the dense bed is uniform in the separator and the horizontal velocity in the dense bed is zero.

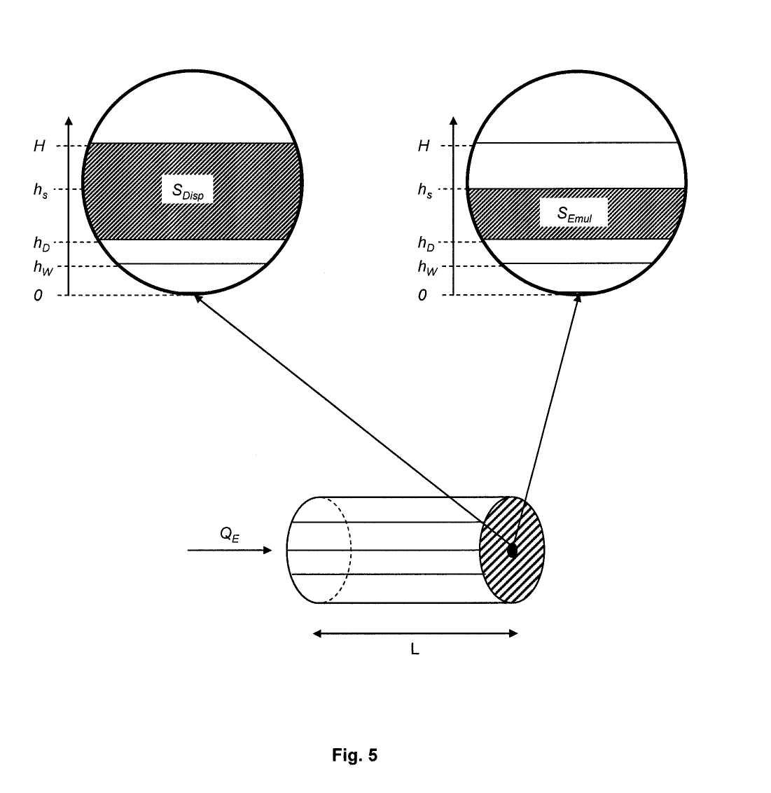

The vertical section above the dense bed therefore remains constant over the entire length of the separator. This section is the available section (S_{Disp}) for passage of the emulsion and of the oil already separated in the separator (see FIG. 5). In first approximation, we consider that the emulsion and the oil have the same horizontal velocity (V_{moy}) and that this velocity remains constant over the entire length of the separator. Furthermore, the variation of the emulsion+oil flow rate in the separator is not taken into account because we consider that flow rate Q_{W} is negligible compared to Q_{E}. We can thus write:

$${V}_{may} = \frac{{Q}_{π}}{{S}_{Disp}} \qquad Eq . 1$$

The residence time of the emulsion in the separator is thus evaluated with the relation:

$${T}_{sed} = \frac{{S}_{Disp} L}{{Q}_{E}} = \frac{L}{{V}_{may}} \qquad Eq . 2$$

Since the free water phase is maintained at a constant value and the thickness of the dense bed is considered to be fixed, the residence time directly depends on the section of passage of the fluid in the separator. S_{Disp}, therefore on the emulsion thickness, (H_{Disp}=H−h_{D}), and therefore on the dense bed thickness h_{D}-h_{W}.

If, for example, the thickness of the dense bed increases, the section of passage of the fluid S_{Disp} decreases and the velocity of the fluid increases. The residence time and the amount of water decanted will be lower, hence the existence of a state of equilibrium for which the amount of water decanted equals the sum of the amount of water coalesced. We then write a balance on the residence time, by taking into consideration the volume of water v_{W} that leaves the dense bed through interfacial coalescence with the free water phase during the residence time and the volume of water v_{S} dispersed in the emulsion reaching the dense bed through sedimentation;

v_{S}=Q_{S}T_{Sed}=Q_{W}T_{Sed}=v_{W} Eq. 3

Determination of v_{S}

The volume of water passed into the dense bed during the residence time equals the volume of water lost by the emulsion during the same time, and the latter is the difference between the volume of water v_{E} that enters the separator and volume v_{SW} that leaves the downcomer of the separator:

v_{S}=v_{E}−v_{S/W} Eq. 4

The volume of water that enters the separator during the residence time is as follows:

v_{S}=φ₀Q_{E}T_{Sed} Eq. 5

The volume of water that leaves the separator is linked with the water flow rate at the outlet of the downcomer Q_{S/W}:

v_{S/W}=Q_{S/W}T_{Sed} Eq. 6

The water flow rate at the downcomer outlet therefore has to be evaluated. We consider that the velocity (V_{moy}) of the assembly consisting of emulsion+oil already separated is uniform in the separator, it therefore remains constant in all the sections of the passage, including the last one. This simplification is confirmed by observation and it is valid if the lost water volume v_{S} is substantially smaller than the volume of water that has entered the separator v_{E}.

To simplify the model, we also impose that what is found in the last section of the separator is what leaves the downcomer. In the last separator section, the available section for the passage is occupied by an oil band and by an emulsion band. If the surface area occupied by the emulsion in the last section is denoted by S_{Emul}, the water flow rate leaving the downcomer can be defined as follows (see FIG. 5):

Q_{S/W}=φ₀V_{moy}S_{Emul} Eq. 7

Surface area S_{Emul} of the emulsion in the last section depends on the height of the interface h_{S} between the emulsion and the oil band already separated.

To evaluate this height h_{S}, we consider a static evolution model of the sedimentation front and we modify it by taking into account the dynamic effects present in the separator.

The volume of the drops evolves over time according to the relation as follows:

$$\frac{d v / {v}_{0}}{d t} = α \frac{1}{{τ}_{c}} \qquad Eq . 8$$

The collision frequency between the drops must also take account of the collisions due to the flow in the separator:

$$\begin{matrix}\frac{1}{{τ}_{c}} = \frac{{V}_{St 0} {f}_{0}}{D [ {( \frac{{φ}_{m}}{{φ}_{0}} )}^{1 / 3} - 1 ]} \frac{D}{{D}_{0}^{2}} + \overline{K} \\ where \text{:} & Eq . 9 \\ \{ \begin{matrix}{Vst}_{0} = \frac{Δρ {gD}_{0}^{2}}{18 μ} & f ( {φ}_{0} ) = {( 1 - {φ}_{0} )}^{5.3} \\ \overline{K} = \frac{6}{π} {φ}_{0} & \frac{{Q}_{E}}{{S}_{Disp} ( H - {h}_{D} )}\end{matrix} & Eq . 10\end{matrix}$$

In Equation 9, the first part takes account of the impacts between the drops during sedimentation, whereas the second part considers the interactions due to the flow in the horizontal direction.

Term K̅ is the mean gradient of the velocity in the available section and it is evaluated by assuming a laminar flow. This hypothesis is usually well verified in the separator where velocities of the order of some cm/s are found.

The vertical velocity of descent of the sedimentation front (interface between the separated oil and the residual emulsion) can be written as follows:

$$V = {V}_{{St}_{0}} f ( {φ}_{0} ) \frac{{D}^{2}}{{D}_{0}^{2}} \qquad Eq . 11$$

hence:

$$d V = {V}_{{St}_{0}} f ( {φ}_{0} ) \frac{2 D}{{D}_{0}^{2}} d D \qquad Eq . 12$$

Furthermore:

$$v = \frac{π {D}^{3}}{6} ⇒ d v = \frac{π}{2} {D}^{2} d D \qquad Eq . 13$$

We thus have:

$$\frac{d V}{d t} = {V}_{{St}_{0}} f ( {φ}_{0} ) \frac{4}{π {D}_{0}^{2} D} \frac{d v}{d t} \qquad Eq . 14$$

By combining Equation 8 in Equation 14, and by writing

$${v}_{0} = \frac{π {D}_{0}^{3}}{6} ,$$

we obtain:

$$\frac{d V}{d t} = \frac{2}{3} {V}_{{St}_{0}} f ( {φ}_{0} ) \frac{{D}_{0}}{D} α \frac{1}{{τ}_{c}} \qquad Eq . 15$$

In order to have the interface descent velocity at the time t, we integrate between time t and time to sedimentation rate V_{St}_{₀}f(φ₀)]. We thus have:

$$V = \frac{2}{3} {V}_{{St}_{0}} f ( {φ}_{0} ) \frac{{D}_{0}}{D} α \frac{1}{{τ}_{c}} t + {V}_{{St}_{0}} f ( {φ}_{0} ) \qquad Eq . 16$$

We combine Equation 9 and Equation 16:

$$V = \frac{2}{3} [ \frac{{Vst}_{0}^{2}}{{D}_{0}} \frac{{f ( {φ}_{0} )}^{2}}{{( \frac{{φ}_{m}}{{φ}_{0}} )}^{1 / 3} - 1} + {Vst}_{0} f ( {φ}_{0} ) \frac{{D}_{0}}{D} \overline{K} ] t + {V}_{{St}_{0}} f ( {φ}_{0} ) \qquad Eq . 17$$

To obtain the position of the interface at the time t, we integrate Equation 17 between time t (position of the interface h_{S}) and time t₀:

$${h}_{s} = H - \frac{1}{3} α [ \frac{{Vst}_{0}^{2}}{{D}_{0}} \frac{{f ( {φ}_{0} )}^{2}}{{( \frac{{φ}_{m}}{{φ}_{0}} )}^{1 / 3} - 1} + {Vst}_{0} f ( {φ}_{0} ) \frac{{D}_{0}}{D} \overline{K} ] {t}^{2} - {Vst}_{0} f ( {φ}_{0} ) t \qquad Eq . 18$$

In the model, the emulsion and the oil already separated have the same velocity in all the sections of the separator, therefore the assembly emulsion+oil reaches the last section at the time T_{Sed} after flowing into the separator. The height of the sedimentation interface in the last section thus is:

$${h}_{s} = H - \frac{1}{3} α [ \frac{{Vst}_{0}^{2}}{{D}_{0}} \frac{{f ( {φ}_{0} )}^{2}}{{( \frac{{φ}_{m}}{{φ}_{0}} )}^{1 / 3} - 1} + {Vst}_{0} f ( {φ}_{0} ) \frac{{D}_{0}}{D} \overline{K} ] {T}_{Sed}^{2} - {Vst}_{0} f ( {φ}_{0} ) {T}_{Sed} \qquad Eq . 19$$

Equation 19 depends on the size of drops (D) during sedimentation. Size D that is considered in the model is the size of the drops in the last section. The evolution of the diameter of the drops over time can be monitored by writing Equation 8 as a function of the diameter of the drops and by integrating it in time T_{Sed}:

$$D = \sqrt{\frac{2}{3} α [ \frac{{Vst}_{0} f ( {φ}_{0} ) {D}_{0}}{{( \frac{{φ}_{m}}{{φ}_{0}} )}^{1 / 3} - 1} + {D}_{0}^{2} \overline{K} ] {T}_{SED} + {D}_{0}^{2}} \qquad Eq . 20$$

Knowing the position of the sedimentation interface h_{S} in the last section allows us to evaluate in the same section the surface area occupied by the emulsion, then, via Equations 7 and 6, the volume of water v_{S} lost by the emulsion during residence time T_{Sed}, and spent in the dense bed at the same time:

v_{S}=φ₀Q_{E}T_{Sed}−φ₀S_{Emul}L Eq. 21

The water flow rate leaving the downcomer Qs/w can also be evaluated.

Determination of v_{W}

To evaluate the volume of water that has left the dense bed during the residence time, we take the static case with the hypothesis of zero velocity in the dense bed.

Since the thickness of the dense bed remains constant, as well as the positions of the free water phase-dense bed (h_{W}) and dense bed-emulsion (h_{D}) interfaces, in the dynamic case, term dh_{W}/dt does not represent a displacement of the free water phase-dense bed interface, but a velocity of passage through interface h_{W} of the water present in the dense bed. The displacement is represented below by an asterisk to indicate that it is a virtual and not a real displacement:

$${( \frac{d {h}_{W}}{d t} )}^{*} = \frac{β \frac{Δρ g {φ}_{D}}{μ} ( {h}_{D} - {h}_{W} )}{1 + β \frac{180}{{D}^{2}} \frac{{φ}_{D}^{2}}{{( 1 - {φ}_{D} )}^{3}} ( {h}_{D} - {h}_{W} )} = N \qquad Eq . 22$$

The drop size that is used in the equation is the size evaluated by means of Equation 20. Parameter β is a characteristic parameter of the interfacial film at the water-dense emulsion interface. It directly depends on coefficient σ, the coefficient of interfacial tension between the oil and the water.

The volume of water v_{W} that leaves the dense bed through interfacial coalescence with the free water phase during the residence time thus is:

v_{W}=B_{W}·L·N·T_{Sed} where B_{W} is the width of interface h_{W}. Eq. 21

The balance of the volumes on the dense bed thus is:

φ₀Q_{E}T_{Sed}−φ₀S_{Emul}L=B_{W}·L·N·T_{Sed} Eq. 22

It can then be noted that the parameters of Equation 22 are known or depend on known parameters, except for parameter h_{D}. We then write the model as follows so as to note the unknown of the model, h_{D}:

φ₀Q_{E}T_{Sed}(h_{D})−φ₀S_{Emul}(h_{D})L=B_{W}·L·N(h_{D})·T_{Sed}(h_{D}) Eq. 23

1) A method of separating two dispersed-phase immiscible liquids, wherein the dispersed phase is fed into a gravity separator within which the two liquids are separated by decantation during a sedimentation time T_{SED} during which a first phase consisting of a first liquid is obtained at the bottom of the separator, a second phase consisting of the second liquid is obtained at the top of the separator, a third phase containing the two dispersed-phase immiscible liquids and a fourth phase containing the two immiscible liquids in a dense bed are obtained, characterized in that it comprises:
a—measuring physico-chemical parameters of said liquids and of the dispersed phase,
b—defining a physical separation model as a function of said physico-chemical parameters and of parameters relative to the operation and the sizing of said separator, by considering that said separator works under stationary conditions, using a matter conservation balance for the first fluid within the dense bed to take account of a first coalescence between the first phase and first liquid drops present in the fourth phase, and using an evolution law of size D of the first liquid drops during separation so as to take account of a second coalescence between first liquid drops within the third phase,
c—using said model to determine at least one of said parameters, and
d—carrying out separation according to the values of said parameters.

2) A method as claimed in claim 1, wherein the matter conservation balance for the first fluid within the dense bed leads to the equality of a volume of the first fluid (v_{W}) that has left the dense bed and a volume of the first fluid (v_{S}) that has entered the dense bed, and the volume of the first fluid (v_{W}) that has left the dense bed is defined as a function of a velocity N of passage of the first liquid contained in the fourth phase into the second phase.

3) A method as claimed in claim 2, wherein the volume of the first fluid (v_{S}) that has entered the dense bed is defined as a function of a surface area occupied by the third phase in a last section of the separator S_{EMUL}.

4) A method as claimed in claim 3, wherein S_{EMUL} and N are determined as a function of said evolution law of size D of the first liquid drops during separation.

5) A method as claimed in claim 4, wherein the evolution law of size D of the first liquid drops during separation is estimated by expressing a variation over time of a mean volume of the drops as a function of a coalescence efficiency and of a characteristic coalescence time during sedimentation, and said characteristic time is expressed by taking account of impacts between drops during sedimentation and interactions due to a flow in the horizontal direction of said liquids.

6) A method as claimed in claim 1, wherein the dispersed phase is an emulsion of water and of oil.

7) A method as claimed in claim 1, wherein the parameters determined in stage c are selected from among the following parameters: sedimentation time T_{SED}, parameters relative to the separator sizing, parameters relative to the separator operation, physico-chemical properties of the liquids and of the dispersed phase.

8) A method as claimed in claim 7, wherein the parameters relative to the separator sizing are selected from among the following parameters: length and radius of the separator, height of a downcomer of the separator.

9) A method as claimed in claim 7, wherein the parameters relative to the separator operation are selected from among the following parameters:
parameters relative to the inlet conditions into said separator, such as: inlet flow rate (Q_{E}), fraction of the first liquid (φ_{O}) within the dispersed phase, height (h_{W}) of the first phase in the separator,
parameters relative to the decantation within the separator, such as: heights of the third (h_{S}) and fourth (h_{D}) phases in the separator, and residence time (T_{SED}) in the separator.

10) A method as claimed in claim 7, wherein the parameter determined in stage c is a coefficient of interfacial tension (σ) between the two liquids so as to have a fixed separation efficiency η, and an additive selected in such a way that the dispersed-phase liquids respect the value of the determined interfacial tension coefficient (σ) is added to the dispersed phase.

11) A method as claimed in claim 1, wherein the parameter determined in stage c is length L of the separator so as to have a fixed separation efficiency η, and the separator is sized accordingly to carry out separation.

12) A method as claimed in claim 1, wherein the parameter determined in stage c is the inlet flow rate Q_{E} of the liquids so as to have a fixed separation efficiency η, and the two liquids are injected at this flow rate Q_{E} to carry out separation.

13) A method as claimed in claim 1, wherein the parameter determined in stage c is efficiency η, of the separator.

14) A method as claimed in claim 1, wherein at least one of the following parameters relative to the outflow of said liquids from the separator is also determined: flow rates at the downcomer outlets (Q_{S/W}, Q_{S/H}), water fraction at the downcomer outlet (φ_{S}), separator efficiency (η), height of the sedimentation front (h_{S}), height of the interface between the third and fourth phases (h_{D}), water flow rate at a water outlet of the separator (Q_{W}), and surface area occupied by the third phase in a last section of the separator (S_{EMUL}).
